(19) United States
(12) Patent Application Publication
(10) Pub. No.: US 2012/0324388 A1
(43) Pub. Date: Dec. 20, 2012

(54) PIE CHART GRAPHICAL USER INTERFACE

(75) Inventors: Santhosh Rao, Bangalore (IN); Suvodeep Das, Bangalore (IN); Radha Phani Sunkara, Bangalore (IN)

(73) Assignee: Business Objects Software Limited, Dublin (IE)

(21) Appl. No.: 13/163,409

(22) Filed: Jun. 17, 2011

(51) Int. Cl. G06F 3/048

(52) U.S. Cl. 715/771

(57) ABSTRACT

A pie chart comprising a pie having at least two slices and a selector head is displayed in a graphical user interface. The selector head is rotatable around a circular selection assist track having a center point corresponding to a center point of the pie. In addition, the graphical user interface can display information associated with/complementary to a first selected slice. Thereafter, user-generated input is received changing a position of the selector head from the first slice to a second slice. This movement of the selector head causes information associated with the second slice to be displayed in the graphical user interface. In some implementations, a highlight display unit and/or a legend can also be provided. Related apparatus, systems, methods, and articles are also described.

### RELATED APPLICATION

This application claims priority to U.S. patent application Ser. No. 29/391,777 entitled “Graphical User Interface for an Electronic Display” filed on May 12, 2011, the contents of which are hereby incorporated by reference.

### FIELD

The subject matter described herein relates to a graphical user interface for rendering and navigating a pie chart as well as for displaying complementary information pertaining to the pie chart.

### BACKGROUND

Pie charts have long been shown to be an effective means of conveying data. Pie charts are increasingly being rendered on computer and mobile phone displays having touch screen interfaces. Many products on such devices allow a user to rotate the pie portion of the pie chart as a whole, like a roulette wheel. However, such an arrangement is disadvantageous in that there are often unpredictable stop positions of the rotating pie, it can be challenging to select thin pie slices easily, there can be an inability to select adjacent pie slices (because this can require minute rotation of the pie), and focus on the slice being viewed can be lost because of the displacement from the original slice.

Moreover, pie charts inherently pose a problem for users with impairments. For example, patterns are sometimes used instead of colors to assist visually challenged users better distinguish slices. However, such an arrangement is not always pleasing to the eye. In addition, selecting slices of pie charts on touch screen devices can be problematic for users having motor coordination difficulties.

### SUMMARY

In one aspect, a pie chart comprising a pie, at least two slices and a selector head is displayed in a graphical user interface. The selector head is rotatable around a circular selection assist track that has a center point corresponding to a center point of the pie. The selector head can point to a first slice and the graphical user interface can display information associated with the first slice. User-generated input is later received that changes (directly or indirectly) a position of the selector head from the first slice to a second slice. Thereafter, information is displayed in the graphical user interface that is associated with the second slice.

In some variations one or more of the following can optionally be included. For example, the graphical user interface in some implementations displays the selection assist track while in other variations the selection assist track is not displayed (i.e., it is not visible). The user-generated input can be obtained from a wide variety of input devices including touch screens (forming part of touch screen computing devices), mice, trackballs, joysticks, and the like.

The graphical user interface can display a highlight display unit that displays information characterizing the slice being pointed to by the selector head. The highlight display unit can include two graphical user interface elements. The first graphical user interface element of the highlight display unit, when activated, causes the selector head to rotate clockwise by one slice, while the second graphical user interface element of the highlight display unit, when activated, causes the selector head to rotate counterclockwise by one slice. In some cases, the highlight display unit can be selectively removed from the graphical user interface when another graphical user interface element is activated.

The graphical user interface can display a legend identifying each of the slices. The legend can comprise a plurality of legend graphical user interface elements each being associated with one of the slices and which, when activated, cause the selector head to change position to the corresponding slice.

A user-generated gesture can be received that is associated which results in a modified pie being displayed that excludes the slice associated with the gesture. The gesture can be user-generated input from any type of input device that is initiated on the associated slice and terminated external to such slice. Alternatively, the gesture removing the slice can comprise selection of a graphical user interface element associated with the slice for a period of time greater than or equal a pre-defined threshold (e.g., three seconds, etc.). This latter graphical user interface element can form part of the pie/slice or it can be external to the pie (e.g., the legend graphical user interface elements).

User-generated gestures activating graphical user interface elements can also be used to display additional information to one or more of the slices and/or to display different forms of charts such as bar charts.

Systems and methods consistent with this approach are described as well as articles that comprise a tangibly (e.g., non-transitorily, etc.) embodied machine-readable medium operable to cause one or more machines (e.g., computers, etc.) to result in operations described herein. Similarly, computer systems are also described that may include a touch screen computing device, a processor and a memory coupled to the processor. The memory may include one or more programs that cause the processor to perform one or more of the operations described herein, some of which are responsive to user input via a touch screen of the touch screen computing device. In addition, operations defined by computer implemented methods can be executed by one or more data processors within a single computing system or distributed among two or more computing systems.

Implementations of the current subject matter can provide one or more advantages. For example, the current subject matter provides enhanced usability by allowing a user to select a particular slice of a pie chart regardless of size or location. In addition, the current subject matter allows a user to dynamically examine the effect of one slice or multiple slices over an entire pie chart. For users who are unable to distinguish colors, the location of the selector head and the corresponding values/information displayed in the highlight display unit allows such users to quickly identify the selected slice. Lastly, the current subject matter is advantageous because it allows a user to easily remove a pie slice from the pie chart to examine the resulting pie chart. This arrangement allows for a finer comparison of small values in a pie where one slice (or a few slices) consumer a large portion of the pie.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a process flow diagram illustrating aspects of a method having one or more features consistent with implementations of the current subject matter;

FIG. 2 is a diagram illustrating a first view of a graphical user interface displaying a pie chart;

FIG. 3 is a diagram illustrating a second view of the graphical user interface displaying a pie chart;

FIG. 4 is a diagram illustrating a third view of the graphical user interface displaying a pie chart;

FIG. 5 is a diagram illustrating a fourth view of the graphical user interface displaying a pie chart;

FIG. 6 is a diagram illustrating a fifth view of the graphical user interface displaying a pie chart and a comparison view of the pie chart;

FIG. 7 is a diagram illustrating a sixth view of the graphical user interface displaying a pie chart;

FIG. 8 is a diagram illustrating a seventh view of the graphical user interface displaying a pie chart;

FIG. 9 is a diagram illustrating an eighth view of the graphical user interface displaying a pie chart; and

FIG. 10 is a block diagram illustrating an exemplary distributed computer system.

When practical, similar reference numbers denote similar structures, features, or elements.

### DETAILED DESCRIPTION

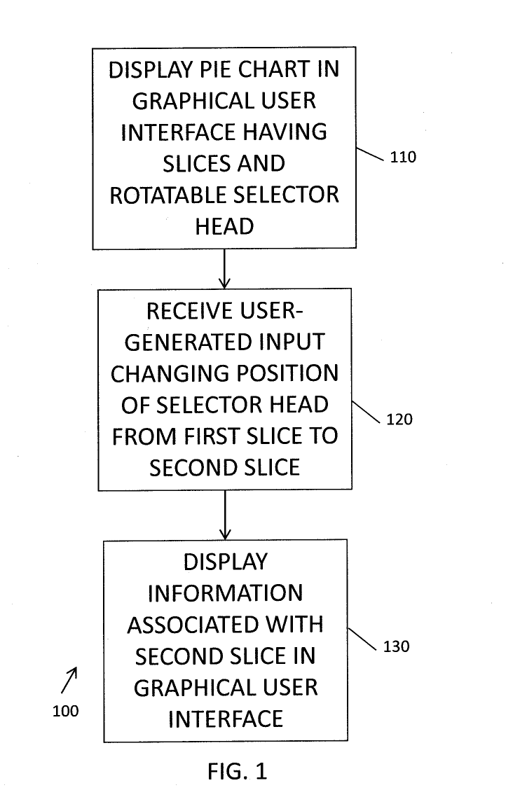

FIG. 1 is a process flow diagram 100 in which, at 110, a pie chart comprising a pie having at least two slices and a selector head is displayed in a graphical user interface. The selector head is rotatable around a circular selection assist track having a center point corresponding to a center point of the pie and it initially points to a first slice. In addition, the graphical user interface can display information associated with/complementary to the first slice. Thereafter, at 120, user-generated input is received changing a position of the selector head from the first slice to a second slice. This movement of the selector head causes, at 130, information associated with the second slice to be displayed in the graphical user interface.

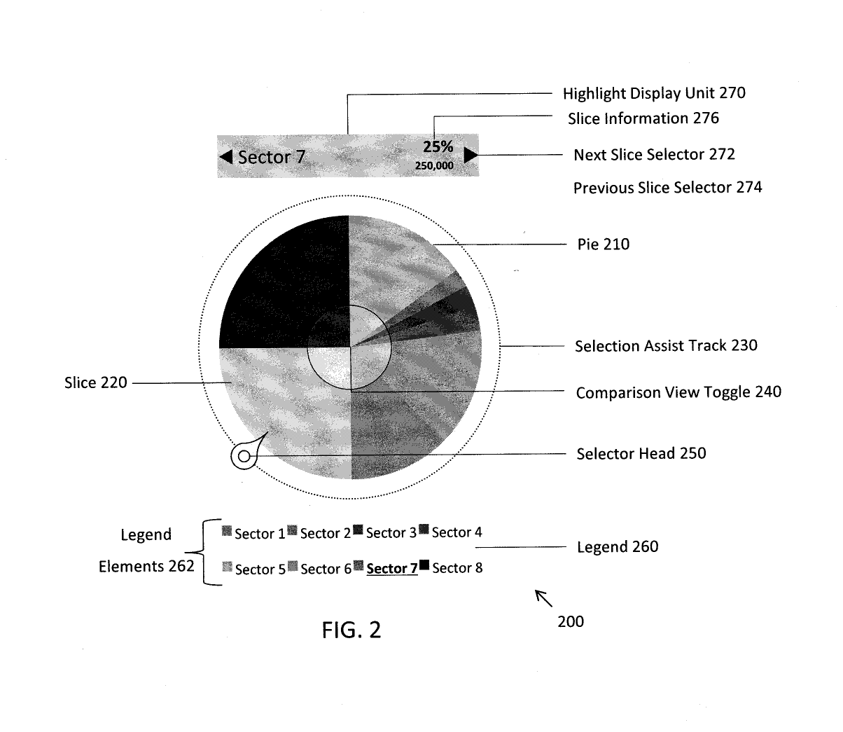

FIG. 2 is a diagram 200 illustrating a graphical user interface 200 of a pie chart having a pie 210 including two or more slices 220 (while references are sometimes made and/or illustrated in connection with a singular slice—features described herein can also, in some cases, be applicable to other slices and so references to slice 220 should not be limited to a particular slice unless otherwise stated). A selection assist track 230 circumferentially surrounds the pie 210. The selection assist track 230 can be rendered in a variety of manners (e.g., broken line, solid line, etc.) or it can remain invisible. A selector head 250 rotates along the selection assist track 230 in order to select a particular slice 220. The default initial position of the selector head can, for example, be the largest slice 220. A comparison view toggle 240 can be included as described in further detail below. A legend 260 can be displayed separate from the pie 210 which displays information associated with/complementary to the pie chart. As will be described in further detail below, the legend 260 can comprise a plurality of graphical user interface elements 262 corresponding to the slices 220 (and the appearance of the graphical user interface element 262 can be modified when the corresponding slice 220 is selected). A highlight display unit 270 can be displayed separate from the pie 210 which displays information associated with/complementary to the pie chart. As will be discussed in further detail below, the highlight display unit 270 can include a first graphical user interface element 272 and a second graphical user interface element 274 which, when activated, allows a user to navigate the pie 210. Unless otherwise explicitly stated, as used herein the term “pie chart” can include variations of pie charts (e.g., exploded pie charts, pie of pie charts, bar of pie charts, etc.) doughnut charts, radar charts, as well as any other type of chart or graph in which a user might want to move a selector to obtain further information about one portion of a chart/graph.

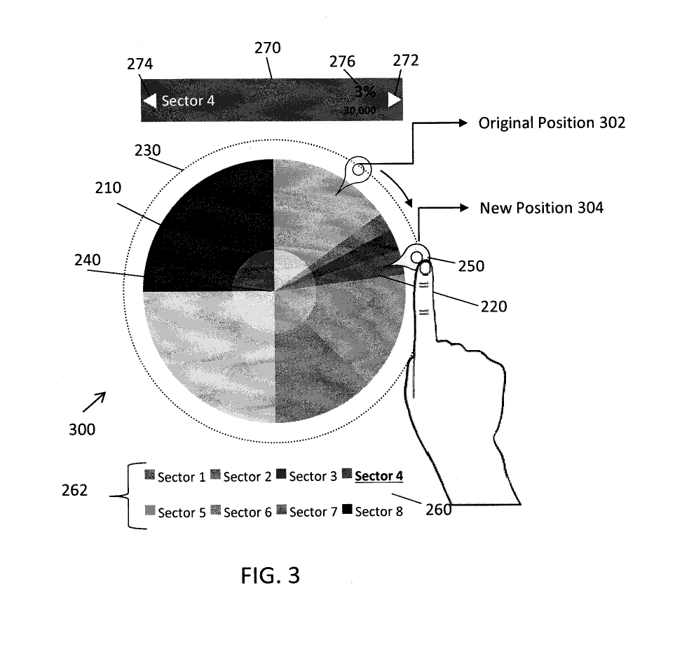

FIG. 3 is a diagram 300 illustrating a selection of a pie slice 210. While this and other figures show user-generated input being initiated by a hand of the user, it will be appreciated that other input interfaces can be utilized such as a computer mouse, a mobile phone joystick, a rollerball, and the like. In this example, a user taps or otherwise selects the selector head 250 at an original position 302 and drags it along the selection assist track 230 to a new position 304. The user movement dragging the selector head 250 need not coincide with the selection assist track 230 provided that it is generally in line with a desired direction along the selection assist track 230 (i.e., clockwise or counter-clockwise). This type of movement is sometimes referred to herein as a “gesture”. The selector head 250 will rotate around the selection assist track 230 and terminate at the slice 220 corresponding to the termination point of the gesture. The selector head 250 can automatically snap into place at a point corresponding to the middle of the slice 220 along the outer circumference of the pie 210. In implementations including a highlight display unit 270, the displayed complementary information 276 is updated to reflect the selected slice 220. In addition, in some arrangements a background color of the highlight display unit 270 can be updated so that it is the same color as the selected slice 220 (which can be helpful to quickly associate the highlight display unit 270 with the selected slice 220). The font color can also change with the background color to ensure that there is proper contrast.

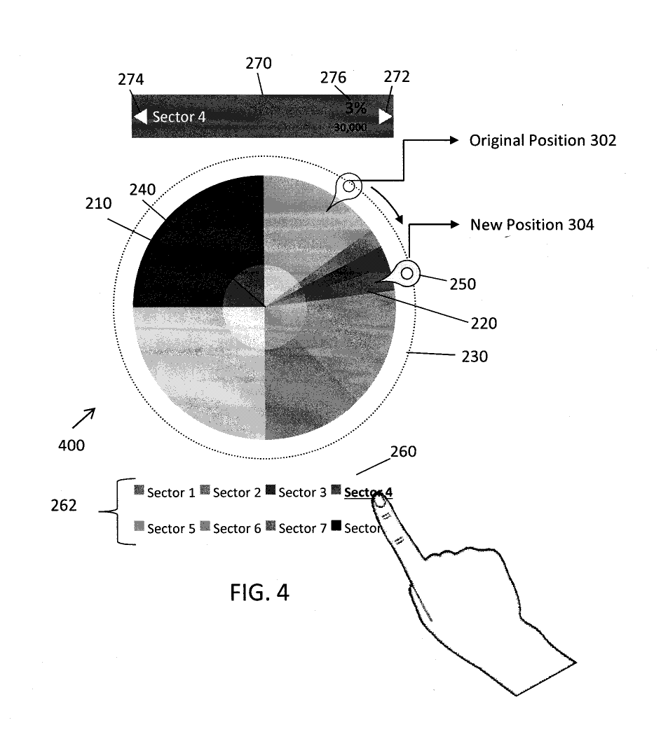

FIG. 4 is a diagram 400 illustrating a selection of a slice 220 using a different technique. In this example, one of the plurality of graphical user interface elements 262 in the legend 260 is selected. This selection causes the selector head 250 to be rotated or re-rendered from the original position 302 to the new position 304 so that it points to a slice 210 corresponding to the selected graphical user interface element 262. In this example, the graphical user interface element 262 associated with Sector 4 is activated causing the selector head 250 to move from a slice 210 corresponding to Sector 1 to the slice corresponding to Sector 4.

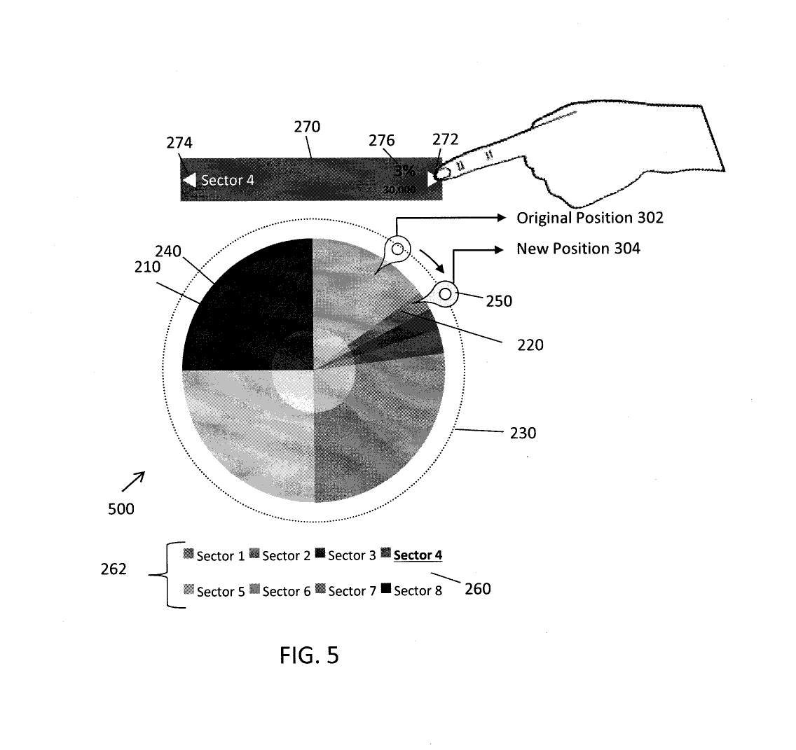

FIG. 5 is a diagram 500 illustrating a selection of a slice 220 using yet a different technique. In this example, the first and second graphical user interface elements 272, 274 of the highlight display unit 270 are activated which respectively causes the selector head 250 to rotate one slice 220 clockwise (e.g., from the original position 302 the new position 304, etc.) or rotate one slice 220 counterclockwise. A user can traverse each of the slices 210 by repeatedly activating either of the graphical user interface elements 272, 274.

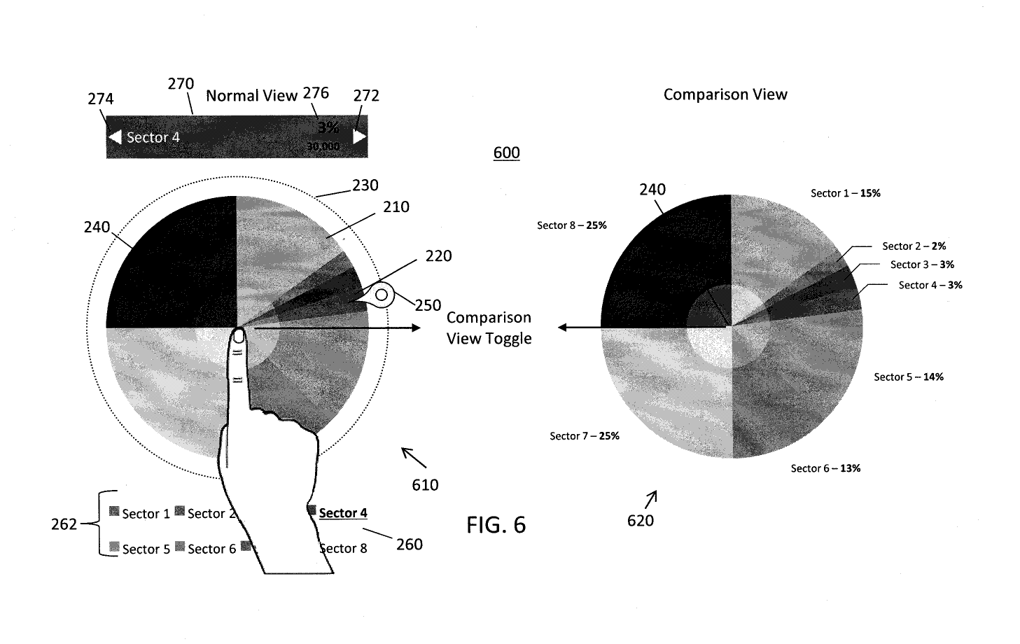

FIG. 6 is a diagram 600 illustrating two different views 610, 620 of the pie chart 200. The first view 610 can show a representation similar to that of FIG. 2 with the highlight display unit 270 and the legend 260. The second view 620 can show a representation more closely approaching a traditional pie chart (i.e., a pie chart with traditionally slice labeling techniques, etc.). Activating the comparison view toggle 240 causes the displayed first view 610 to be replaced with the second view 620. The second view 620 can also include the comparison view toggle 240 which, when activated, causes the displayed second view 620 to be replaced with the first view 610. It will be appreciated that the second view 620 can alternatively comprise a representation of the data illustrated in the pie chart 200. It will be appreciated that the second view can include a variety of representations such as tables, charts to show contribution of a part to its associated whole, such as, bar (column or row), stacked or segmented bar, dot plot, and the like.

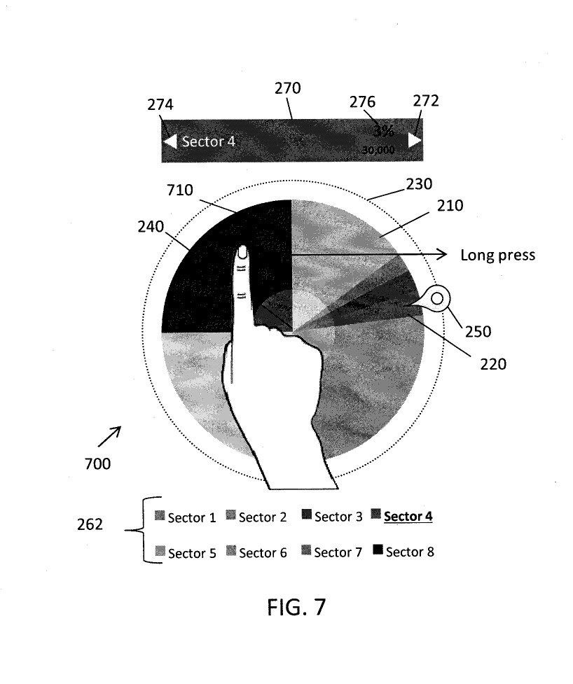

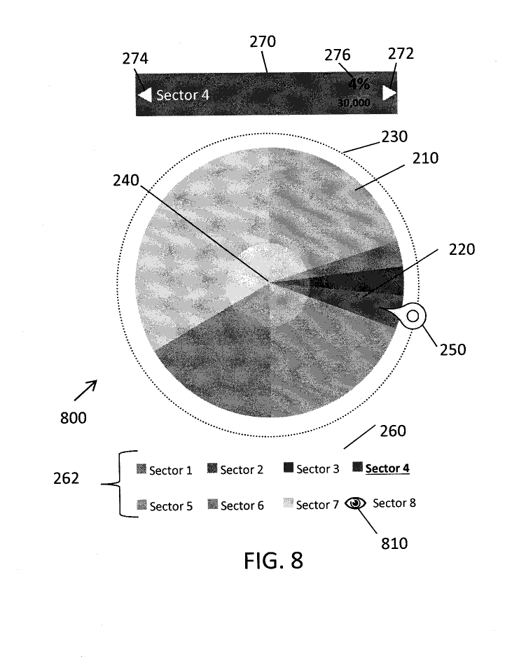

FIG. 7 is a diagram 700 illustrating a removal of a slice 710 from the pie 210. The removal of a slice can be accomplished in a variety of manners. In this example, the user initiates a gesture associated with a particular slice 710 (which differs from the slice 220 to which the selection head 250 is directed). This gesture can, for example, comprise selecting a graphical user interface element (which could comprise the slice 710 itself or a corresponding graphical user interface element 262 in the legend) associated with the slice 710 for a period of time equal to or greater than a pre-defined threshold (e.g., 3 seconds, etc.). The gesture can additionally or alternatively comprise a selection of the graphical user interface element associated with the slice 710 that begins at a point overlapping the slice 710 and extends to a point external to the pie 210. Relatedly, FIG. 8 is a diagram 800 illustrating one technique for adding back a slice 710 that has been removed. In this latter example, a graphical user interface element 810 in the legend 260 that corresponds to the removed slice 710 is visually altered to indicate its removal (in this case in the form of an eye). Activation of this graphical user interface element causes the slice 710 to be replaced in the pie 210.

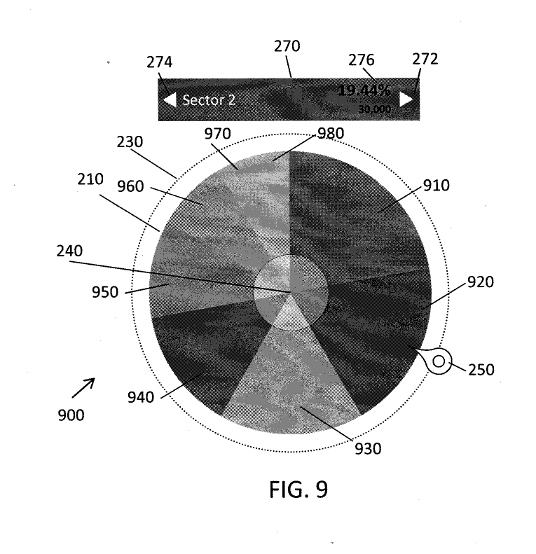

It will be appreciated that the slices of a pie can be displayed in a variety of manners. For example, the diagram 900 of FIG. 9 shows slices 910-980 being arranged according to size. More specifically, slice 910 is the largest slice, slice 920 is the second largest slice continuing until slice 980 which is the smallest slice. The slices 910-980 can be displayed in a monotonically decreasing order clockwise or the slices 910-980 can be displayed in a monotonically increasing order clockwise. Similarly, the slices can be arranged according to other characteristics such as chronologically (if there is a temporal component), alphabetically, and the like. In addition, the starting point/origin of the slices can be at any portion of the pie 210 (as opposed to initiating at “12 o'clock).

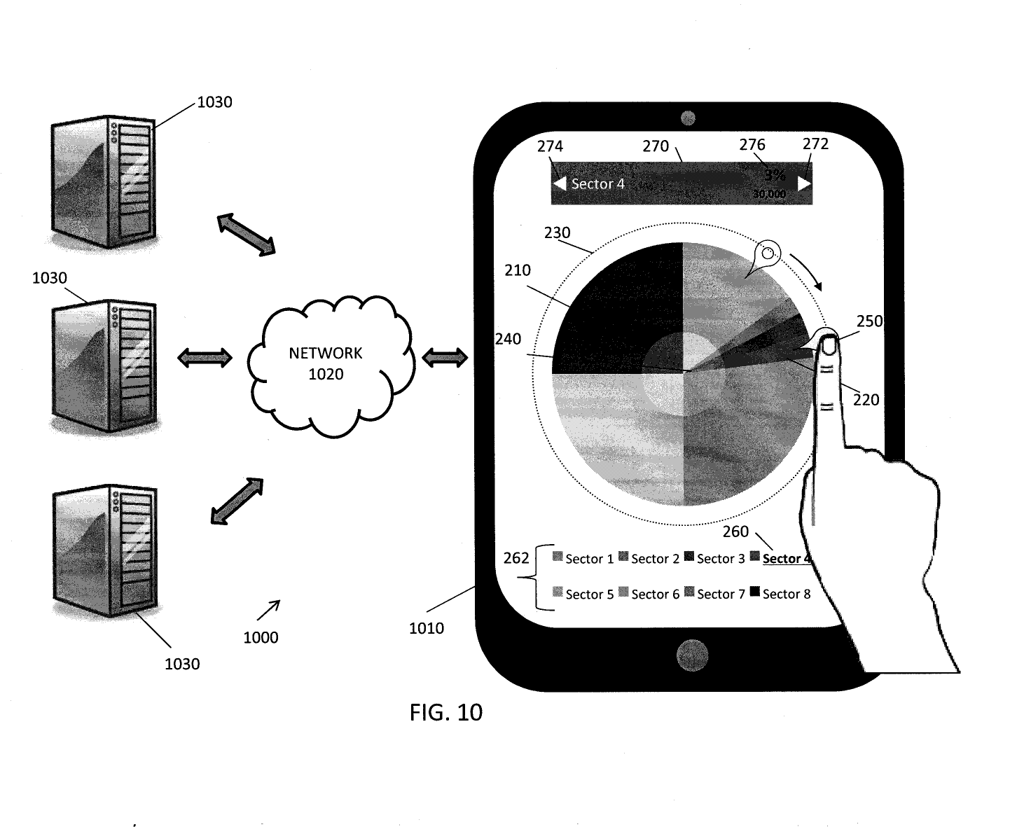

FIG. 10 is a diagram 1000 illustrating a pie chart rendered on a tablet computer 1010. In some arrangements, the software rendering the pie chart is resident on the tablet computer 1010 (as well as the data populating the pie chart). In other arrangements the table computer 1010 is coupled to one or more remote computing systems 1030 (e.g., services) via a network 1020. In this latter arrangement, the data required to render the pie chart can be transmitted from one or more of the remote computing systems 1030 to the tablet computer 1010. User-generated input via the tablet computer 1010 can then be transmitted back to the remote computing system(s) 1030 (which may result in further data being transmitted from the remote computing system(s) 1030 to the tablet computer 1010 in order to update the pie chart). In other arrangements, a hybrid approach is implemented in which there can be software resident on the table computer 1010 to render the pie chart and the values for a particular rendering of the pie chart are obtained from a remote computing system(s) 1030.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens (e.g., tablet computers such as IPAD tablets, XOOM tablets, PLAYBOOK tablets, etc.) or other touch-sensitive devices such as single or multi-point resistive or capacitive trackpads, voice recognition hardware and software, optical scanners, optical pointers, digital image capture devices and associated interpretation software, and the like.

Aspects of the subject matter described herein may be implemented in a computing system that includes a back-end component (e.g., as a data server), or that includes a middleware component (e.g., an application server), or that includes a front-end component (e.g., a client computer having a graphical user interface rendering the pie chart or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. For example, the various representations of the elements of the graphical user interface illustrated in the drawings, such as the selector head, can take a wide variety of forms.

Although a few variations have been described in detail above, other modifications or additions are possible. As stated above, the principles described herein are applicable to any type of chart or graph in which it might be useful to select a grouping of data in order to obtain further information. In particular, further features and/or variations can be provided in addition to those set forth herein. For example, the implementations described above can be directed to various combinations and subcombinations of the disclosed features and/or combinations and subcombinations of several further features disclosed above. In addition, it will be appreciated that references to direction, e.g., left, right, up, down, clockwise, counterclockwise, can be replaced with its opposite, e.g., left in place of right, or another direction, e.g., down in place of left. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
displaying, in a graphical user interface, a pie chart comprising a pie, at least two slices and a selector head, the selector head being rotatable around a circular selection assist track having a center point corresponding to a center point of the pie, the selector head pointing to a first slice, the graphical user interface displaying information associated with the first slice;
receiving user-generated input changing a position of the selector head from the first slice to a second slice; and
displaying, in the graphical user interface, information associated with the second slice.

2. A method as in claim 1, wherein the graphical user interface displays the selection assist track.

3. A method as in claim 1, wherein the selection assist track is not visible.

4. A method as in claim 1, wherein the user-generated input is obtained via a non-tactile input device.

5. A method as in claim 1, wherein the user-generated input is obtained via a touch screen of a touch screen computing device.

6. A method as in claim 1, wherein the graphical user interface further displays a highlight display unit, the highlight display unit displaying information characterizing the slice being pointed to by the selector head.

7. A method as in claim 6, wherein the highlight display unit comprises two graphical user interface elements, the first graphical user interface element, when activated, causing the selector head to rotate clockwise by one slice, the second graphical user interface element, when activated, causing the selector head to rotate counterclockwise by one slice.

8. A method as in claim 6, wherein the graphical user interface comprises a graphical user interface element, which when activated, causes the highlight display unit to be removed from the graphical user interface.

9. A method as in claim 1, wherein the graphical user interface further displays a legend identifying each of the slices.

10. A method as in claim 9, wherein the legend comprises a plurality of legend graphical user interface elements, each legend graphical user interface being associated with one of the slices and, when activated, causing the selector head to change position to the corresponding slice.

11. A method as in claim 1, wherein the graphical user interface is displayed on a touch screen computing device and the method further comprises:
receiving a user-generated gesture associated with a slice via a touch screen of the touch screen computing device
displaying, in the graphical user interface, a modified pie excluding the slice associated with the gesture.

12. A method as in claim 11, wherein the gesture is initiated on the associated slice and terminates external to such slice.

13. A method as in claim 12, wherein the gesture comprises selection of a graphical user interface element associated with the slice for a period of time greater than or equal a pre-defined threshold.

14. A method as in claim 13, wherein the selected graphical user interface element associated with the slice is internal to the pie.

15. A method as in claim 13, wherein the selected graphical user interface element is external to the pie.

16. A method as in claim 1, further comprising:
receiving a user-generated gesture initiated on one of the slices and terminating external to such slice;
displaying, in the graphical user interface, a modified pie excluding the slice associated with the gesture.

17. A method as in claim 1, further comprising:
receiving a user-generated gesture activating at least one graphical user interface element in the pie; and
displaying, in the graphical user interface, information characterizing at least one of the slices overlaid and/or adjacent to each corresponding slice.

18. A method as in claim 1, further comprising:
receiving a user-generated gesture activating at least one graphical user interface element in the pie; and
displaying, in the graphical user interface, a bar chart corresponding to the pie chart.

19. A computer program product comprising a non-transitory machine-readable medium storing instructions that, when executed by at least one programmable processor, cause the at least one programmable processor to perform operations comprising:
displaying, in a graphical user interface, (i) a pie chart comprising a pie having at least two slices and a selector head, the selector head being rotatable around a circular selection assist track having a center point corresponding to a center point of the pie, the selector head pointing to a first slice, (ii) a highlight display unit displaying information characterizing the slice being pointed to by the selector head, the highlight display unit comprising two graphical user interface elements, the first graphical user interface element, when activated, causing the selector head to rotate clockwise by one slice, the second graphical user interface element, when activated, causing the selector head to rotate counterclockwise by one slice, and (iii) a legend identifying each of the slices, the legend comprising a plurality of legend graphical user interface elements, each legend graphical user interface being associated with one of the slices and, when activated, causes the selector head to change position to the corresponding slice;
receiving user-generated input changing a position of the selector head from the first slice to a second slice; and
displaying, in the graphical user interface, information associated with the second slice.

20. A system comprising:
a touch screen computing device comprising:
at least one programmable processor, and
a machine-readable medium storing instructions that, when executed by the at least one processor, cause the at least one programmable processor to perform operations comprising:
displaying, in a graphical user interface, a pie chart comprising a pie having at least two slices and a selector head, the selector head being rotatable around a circular selection assist track having a center point corresponding to a center point of the pie, the selector head pointing to a first slice;
receiving user-generated input via a touch screen of the touch screen computing device changing a position of the selector head from the first slice to a second slice; and
displaying, in the graphical user interface, information associated with the second slice.
